(19) United States
(12) Patent Application Publication
(10) Pub. No.: US 2010/0212378 A1
(43) Pub. Date: Aug. 26, 2010

(54) ELECTRIC STEERING LOCK FOR MOTORCYCLE

(76) Inventors: Pei-Ting Chen, Kuei San Industrial Park (TW); Chong-Guang Chen, Kuei San Industrial Park (TW); Zhi Wen Hou, Kuei San Industrial Park (TW); Wei-Chun Lin, Kuei San Industrial Park (TW); Chun-Yi Sun, Kuei San Industrial Park (TW)

Correspondence Address: HDLS Patent & Trademark Services, P.O. BOX 220746, CHANTILLY, VA, 20153-0746, US

(21) Appl. No.: 12/620,014

(22) Filed: Nov. 17, 2009

(30) Foreign Application Priority Data
Feb. 20, 2009 (TW) 098105432

(51) Int. Cl. B60R 25/02; H02K 7/06

(52) U.S. Cl. 70/211; 318/14

(57) ABSTRACT

An electric steering lock for a motorcycle includes a housing, a transmission assembly, a spindle, and a circuit board. The transmission assembly has an actuator, a first gear, a second gear and a sliding block each arranged within the housing in transmissive engagement with each other. The spindle is assembled with the sliding block and acts in the second space. The circuit board is arranged on the bottom of the housing. The primary control chip of the motorcycle controls the circuit board to make the transmission assembly to drive the spindle to move accordingly. The sliding block touches an inner wall of the casing to make it unable to move forwards or backwards any more. The current of the actuator at this time is larger than that in its normal operation. The rotation of the actuator is ceased by the circuit board when a variation in current of the actuator is detected by the circuit board.

### BACKGROUND OF THE INVENTION

1. Field of the Invention

The present invention relates to a lock, and in particular to an electric steering lock for a motorcycle.

2. Description of Prior Art

Recently, many automobile manufacturers combine a Passive Keyless Entry (PKE) system with an Electric Steering Lock in newly-developed automobiles, whereby a driver needs not to take the key out of his/her pocket and its anti-theft effect can be enhanced.

The same idea has been applied to two-wheeled vehicles such as motorcycles. However, the steering lock of this two-wheeled vehicle is still a mechanical lock, but not an electric steering lock used in the automobile. According to the PKE system for a motorcycle available in the market, after an engine control unit (ECU) authenticates the instructions sent by a Key Fob chip, the user still needs to rotate a dial of the steering lock or rotate mechanical members on the steering stem. The principle for unlocking the steering lock is similar to the traditional mechanical steering lock that it still needs a key to be inserted into the dial. That is to say, the key is inserted in an ignition switch. However, there is no electric steering lock for a motorcycle.

### SUMMARY OF THE INVENTION

The present invention is to provide an electric steering lock for a motorcycle. After the user has parked the motorcycle, the user rotates the handle to one side and presses a positioning switch. Then, the user presses a locking/unlocking button (the locking button and the unlocking button are the same one). As a result, the spindle of the electric steering lock for a motorcycle will be inserted into an insertion hole of the steering stem. When the user intends to unlock the steering lock, the user only needs to touch the locking/unlocking button to make the spindle of the steering lock to retract from the insertion hole, whereby the user can rotate the handle again.

The present invention is to provide an electric steering lock for a motorcycle, which includes:
a housing having a first space and a second space, a front end of the second space having a through-hole, a rear end of the second space having a trough;
a transmission assembly comprising an actuator, a first gear, a second gear and a sliding block each arranged within the first and second spaces in transmissive engagement with each other;
a spindle assembled with the sliding block and penetrating the through-hole to act in the second space; and
a circuit board arranged in a bottom of the housing and electrically connected with the actuator and a primary control chip;
wherein the primary control chip controls the circuit board to make the transmission assembly to drive the spindle to move accordingly, the sliding block touches an inner wall of the casing to make it unable to move forwards or backwards any more, a current of the actuator at this time is larger than that in its normal operation, the rotation of the actuator is ceased by the circuit board when a variation in current of the actuator is detected by the circuit board.

### BRIEF DESCRIPTION OF THE DRAWINGS

FIG. 1 is an exploded view showing the electric steering lock for a motorcycle according to the present invention;

FIG. 2 is an assembled perspective view showing the external appearance of the electric steering lock for a motorcycle according to the present invention;

FIG. 3 is a schematic view showing an operating state (II) of the present invention;

FIG. 4 is a schematic view showing an operating state (II) of the present invention;

FIGS. 5a and 5b are schematic views showing the spindle of the steering lock of the present invention is pushed outwards;

FIGS. 6a and 6b are schematic views showing the spindle of the steering lock of the present invention is pulled back;

FIG. 7 is a block view showing the circuit on the circuit board of the present invention;

FIGS. 8a to 8f are schematic views each showing the current waveform generated by the circuit board of the present invention;

FIG. 9 is a flow chart showing the steps of locking the steering lock of the present invention; and

FIG. 10 is a flow chart showing the steps of unlocking the steering lock of the present invention.

### DETAILED DESCRIPTION OF THE INVENTION

The characteristics and technical contents of the present invention will be described with reference to the accompanying drawings. However, the drawings are illustrative only but not used to limit the present invention.

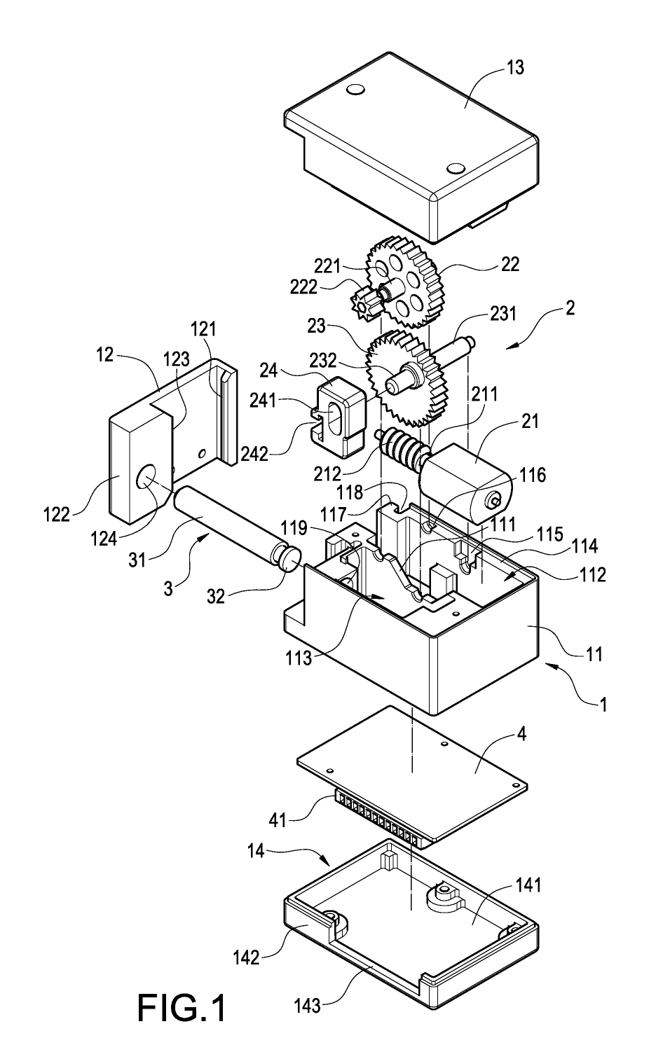

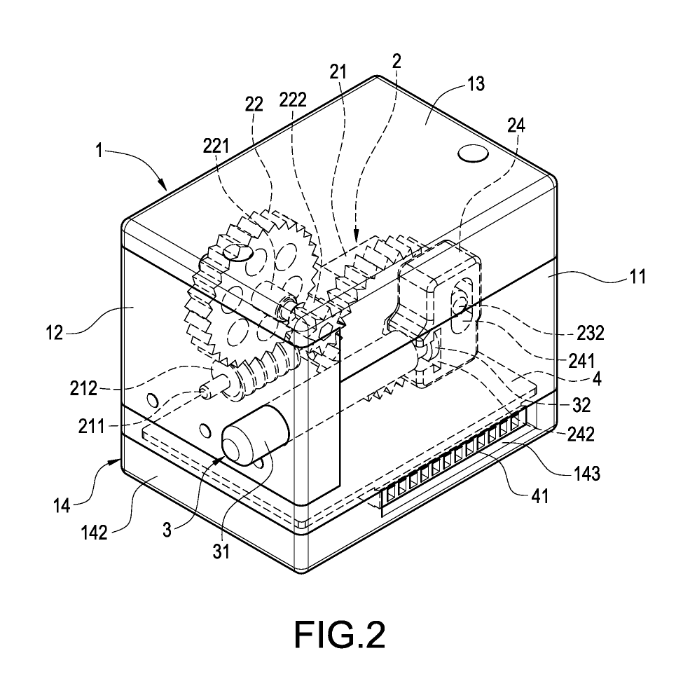

Please refer to FIGS. 1 and 2. FIG. 1 is an exploded view showing the electric steering lock for a motorcycle according to the present invention, and FIG. 2 is an assembled perspective view showing the external appearance of the electric steering lock for a motorcycle according to the present invention. As shown in these figures, the present invention provides an electric steering lock for a motorcycle, which includes a housing 1, a transmission assembly 2, a spindle 3, and a circuit board 4.

The housing 1 is constituted of a casing 11, a front cover 12, an upper cover 13 and a bottom cover 14. The interior of the casing 11 has a partition 111 for separating the interior of the casing 11 into a first space 112 and a second space 113. The transmission assembly 2 is assembled in the two spaces 112, 113. The upper edges of the partition 111 and an inner wall 114 of the first space 112 have a first group of recesses 115 and a second group of recesses 116 respectively in which shafts of the transmission assembly 2 are rotatably assembled. The front end of the first space 112 extends to form two blocks 117. The two blocks 117 have an insertion slot 118 respectively. The front end of the second space 113 has a through-hole 119 which the spindle 3 penetrates. The front cover 12 is assembled at a front end of the casing 11. One side of the front cover 12 has an insertion strip 121, and the other side thereof has a protrusion 122. One side of the protrusion 122 has an insertion strip 123. The insertion stripes 121, 123 are inserted in the insertion slot 118. The protrusion 122 is provided with a through-hole 124 corresponding to the through-hole 119. After the transmission assembly 2 is assembled in the casing 11, the upper cover 13 covers above the casing 11, thereby fixing the transmission gears and sealing the casing 11. The bottom cover 14 is mounted to the bottom of the casing 11. The interior of the bottom cover 14 has an accommodating space 141 for receiving a circuit board 4. A surrounding wall 142 of the bottom cover 14 is provided with a notch 143 through which a connector 41 on the circuit board 4 is exposed to the outside.

The transmission assembly 2 is constituted of an actuator 21, a first gear 22, a second gear 23 and a sliding block 24. The actuator 21 is a motor that is arranged in the first space 112. The actuator 21 is provided with a shaft 211. The shaft 211 extends to have a worm screw 212.

Both side surfaces of the first gear 22 are provided with a concentric shaft 221 respectively. The shaft 221 spans the second group of recesses 116 on the upper edges of the partition 111 and the inner wall 114, so that the first gear 22 is located in the first space 112 to be engaged with the worm screw 212. One of the shafts 221 is provided at its end with a pinion 222 located in the second space 113. One side of the second gear 23 has a long shaft 231. The long shaft 231 spans the first group of recesses 115 on the upper edges of the partition 111 and the inner wall 114, so that the second gear 23 is located in the second space 113 and to be engaged with the pinion 222. The other side surface of the second gear 23 is provided with an eccentric shaft 232 for driving the sliding block 24 to move. The sliding block 24 is provided with an opening 241. After the eccentric shaft 232 is inserted into the opening 241, the movement of the eccentric shaft 232 in the opening 241 can drive the sliding block 24 to move accordingly. The front end of the sliding block 24 has a T-shape slot 242 for connecting to the spindle 3.

The spindle 3 is arranged in the through-hole 119 and the through-hole 124. The spindle 3 has a pillar 31. One end of the pillar 31 has a T-shape portion 32 that is connected in the T-shape slot 242.

The circuit board 4 is arranged between the casing 11 and the bottom cover 14. The circuit board 4 has a control circuit for controlling the action of the transmission assembly 2, an over-current protection circuit, a ripple detection circuit, and a timer circuit. When the steering lock reaches the locked or unlocked position, the sliding block 24 will touch the inner wall of the casing 11 to make it unable to move forwards or rearwards any more. The current of the actuator at this time is larger than that in its normal operation. Thus, by detecting a variation in current, the circuit board 4 can determine whether the actuator 21 has to be ceased or not. When an over-current is generated, the ripple detection circuit and the timer circuit stop counting the number of ripples and the active duration. With the above over-current detection, the number of ripples and the active duration counted, the circuit board 4 can determine whether the sliding block 24 drives the spindle 3 to reach a predetermined position.

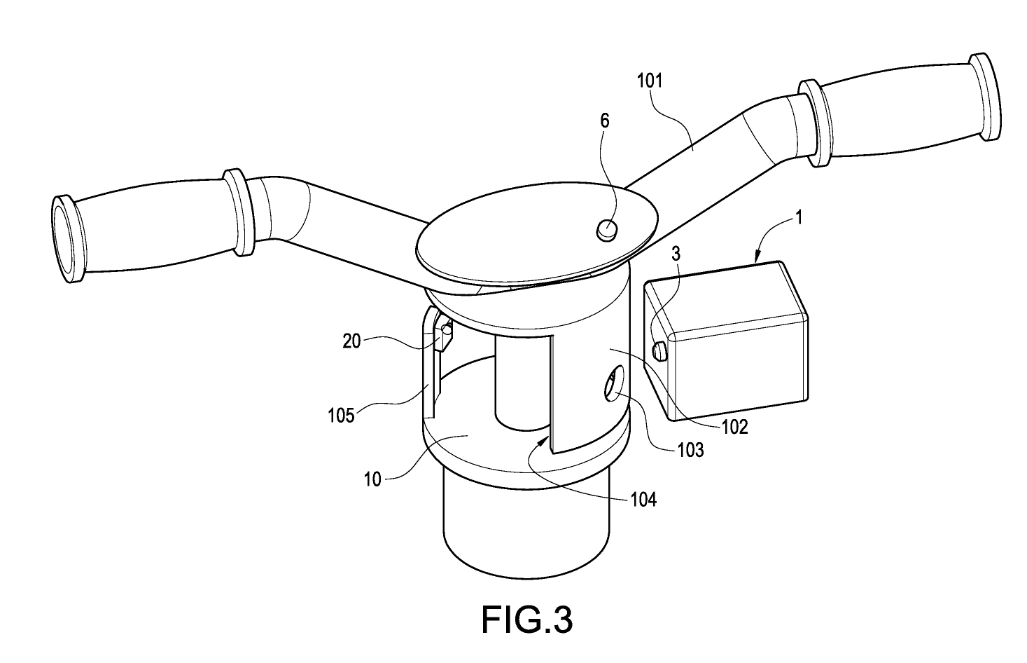

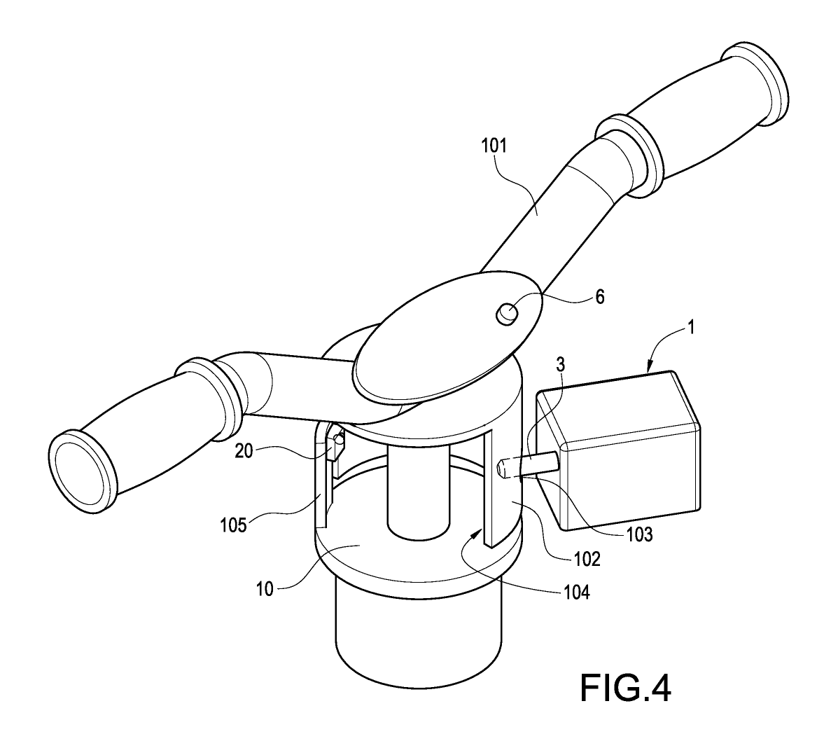

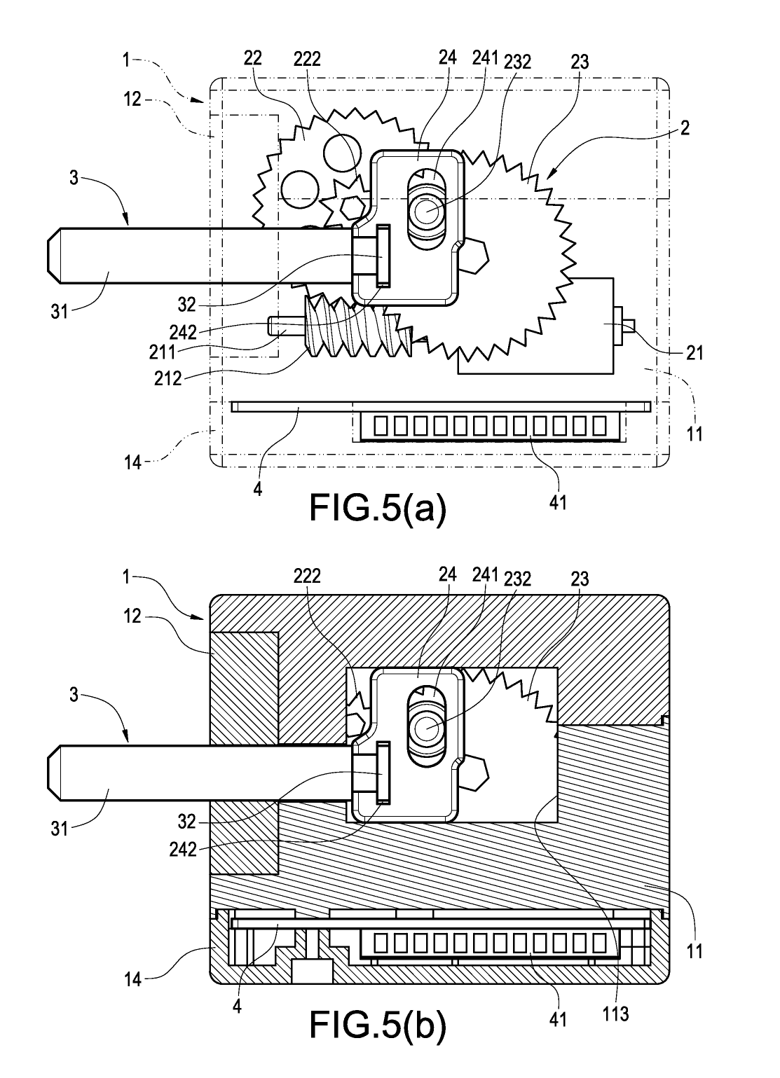

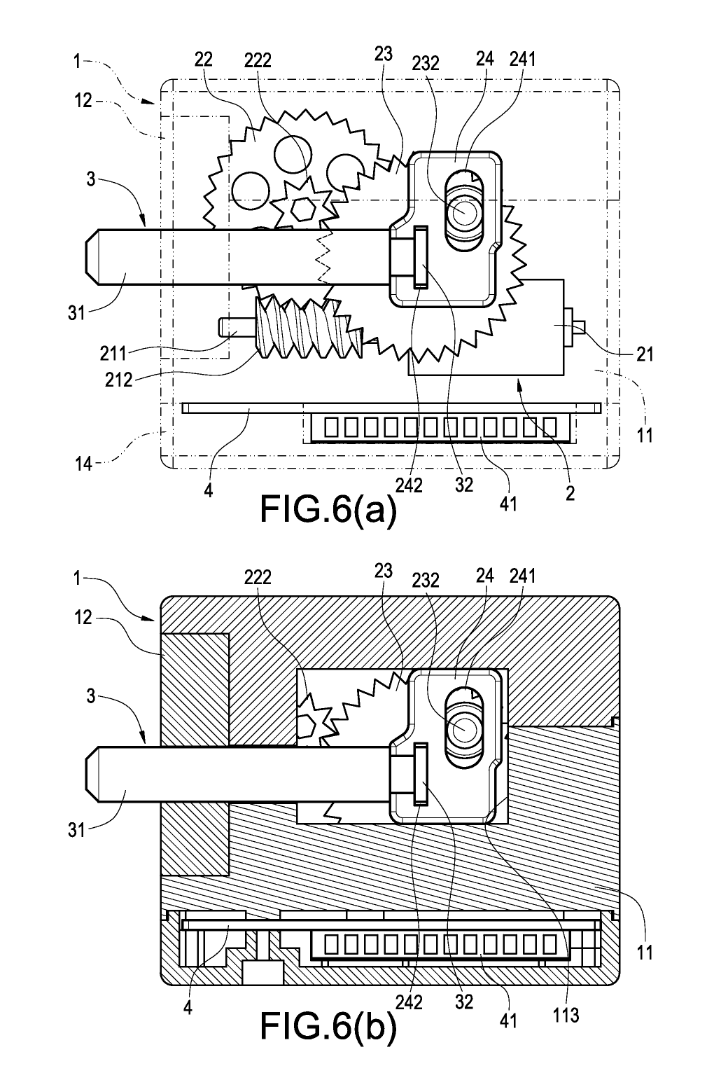

Please refer to FIGS. 3, 4, 5a, 5b, 6a and 6b. FIG. 3 is a schematic view showing an operating state (I) of the present invention, and FIG. 4 is a schematic view showing an operating state (II) of the present invention. FIGS. 5a and 5b are schematic views showing the spindle of the steering lock of the present invention is pushed outwards. FIGS. 6a and 6b are schematic views showing the spindle of the steering lock of the present invention is pulled back. As shown in these figures, when the steering lock of the present invention is in use, the steering lock is fixed to one side of the steering stem 10. The steering stem 10 has a connecting portion 102 driven by a handle 101. The connecting portion 102 has an insertion hole 103 into which the spindle 3 is inserted. The connecting portion 102 is provided with a U-shape notch 104 on one side of the insertion hole 103. The steering stem 10 is provided with a stopper 105 for restricting the moving range of the notch 104. The stopper 105 is provided with a positioning switch 20. Further, the steering stem 10 is provided with a button 6. The positioning switch 20 and the button 6 are electrically connected to the connector 41 of the circuit board 4 by means of electric leads (or a flat cable).

After the user has parked the motorcycle, the user rotates the handle 101 to drive the connecting portion 102 to rotate accordingly. When the connecting portion 102 rotates and one side of the notch 104 presses the positioning switch 20, the positioning switch 20 sends a signal to the circuit board 5, thereby informing that the conditions for activating the actuator 21 are satisfied. Thereafter, if the user presses the button 6, the circuit board 4 will activate the actuator 21, so that the worm screw 212 rotates to drive the first gear 22 to rotate accordingly. Then, the pinion 222 drives the second gear 23, so that the eccentric shaft 232 on one side of the second gear 23 can drive the sliding block 24 to push the spindle 3 outwards. As a result, the spindle 3 is pushed outwards and inserted into the insertion hole 103. At this time, the sliding block 24 will touch the inner wall of the casing 11 to make it unable to move forwards or rearwards any more. The current of the actuator 21 at this time is larger than that in its normal operation. Thus, by detecting the variation in current, the circuit board 4 can make the actuator 21 to stop rotating. When the spindle 3 is pushed outwards, if an over-current signal is sent to the circuit board 4 with the active duration of the actuator shorter than a predetermined period of time, it means that the spindle 3 is not pushed outwards completely or may be blocked by an article. Thus, the circuit board 4 will generate a warning signal to the user and pull the spindle 3 back to its original position. At this time, the user has to make sure whether the steering stem 10 is positioned correctly and re-activate the steering lock.

When the user is unlocking the steering lock, the user only needs to press the button 6. The circuit board 4 will activate the actuator 21, so that the worm screw 212 rotates reversely to drive the first gear 22 to rotate accordingly. Then, the pinion 222 drives the second gear 23 to rotate, so that the eccentric shaft 232 on one side of the second gear 23 drives the sliding block 24 to pull back the spindle 3. After the spindle 2 is pulled back to remove form the insertion hole 103, the sliding block 24 will touch the inner wall of the casing 11 to make it unable to move forwards or rearwards any more. The current of the actuator 21 at this time is larger than that in its normal operation. Thus, by detecting the variation in current, the circuit board 4 can make the actuator 21 to stop rotating. If the timer detects that the active duration of the actuator is shorter than a predetermined period of time, an over-current signal is generated, which means that the spindle 3 has not been pulled back. Thus, the circuit board 4 will generate a warning signal to the user. Thus, the user has to try again to re-lock the steering lock.

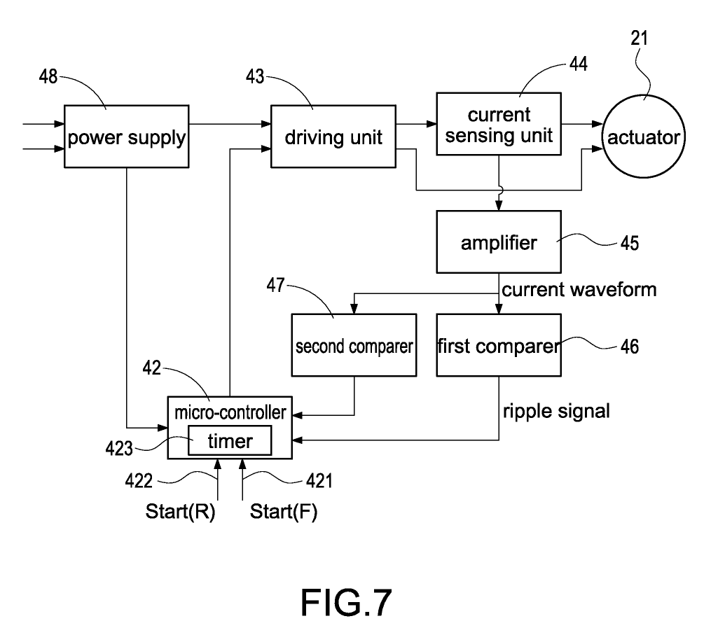

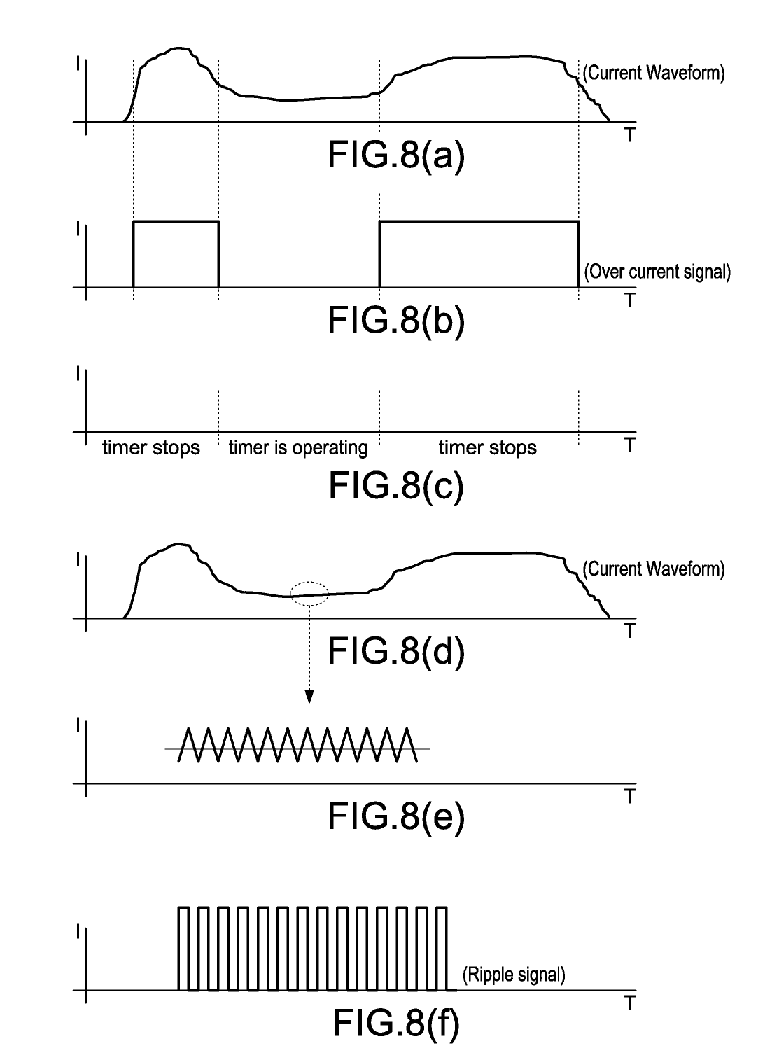

Please refer to FIGS. 7 and 8a to 8f. FIG. 7 is a block view showing the circuit on the circuit board of the present invention. FIGS. 8a to 8f are schematic views each showing the current waveform generated by the circuit board of the present invention. As shown in these figures, the circuit board 4 includes a micro-controller 42, a driving unit 43, a current sensing unit 44, an amplifier 45, a first comparer 46, a second comparer 47, and a power supply 48.

The micro-controller 42 receives a forward rotation signal 421 and a reverse rotation signal 422 inputted by an external device. The micro-controller 42 has a timer 423.

The driving unit 43 is electrically connected with the micro-controller 42 and the actuator 21. When the micro-controller 42 receives the forward rotation signal 421 and the reverse rotation signal 422 inputted by the external device, the driving unit 43 will be activated.

The current sensing unit 44 is electrically connected between the driving unit 43 and the actuator 21 for sensing the variation in current there between.

The amplifier 45 is electrically connected to the current sensing unit 44 for amplifying the current sensed by the current sensing unit 44 (FIG. 8a).

The first comparer 46 is electrically connected to the amplifier 45 and the micro-controller 42 for processing the current waveform outputted by the amplifier 45 into a ripple signal (FIG. 8c), and sending the ripple signal to the micro-controller 42.

The second comparer 47 is electrically connected to the amplifier 45 and the micro-controller 42 for processing the current waveform outputted by the amplifier 45 into an over-current signal (FIG. 8b), and sending the over-current signal to the micro-controller 42.

The power supply 48 is electrically connected to the micro-controller 42 and the driving unit 43 for supplying necessary power to the circuit board 4 and the actuator 21.

According to the present invention, there are three modes for the over-current protection and detection.

Mode 1: When the micro-controller 42 receives a signal indicating the activation of the actuator 21, the micro-controller 42 sends a signal to the driving unit 43, whereby the driving unit 43 can activate the actuator 21. The current for the activation of the actuator 21 is larger than that in its normal operation. The current waveform at this time is shown in FIG. 8a. The waveform shown in FIG. 8b shows the waveform of a current after flowing through the second comparer 47. At this time, the waveform shown in FIG. 8b can be used to trigger the micro-controller 42, so that the micro-controller 42 starts to count the number of pulses and the active duration of the actuator.

Mode 2: When the actuator 21 reaches a steady state, the amplifier 45 and the first comparer 46 convert the ripple signal into a pulse signal as shown in FIGS. 8d to 8f, and send the pulse signal to the micro-controller 42. At this time, the micro-controller 42 starts to count the number of pulses and activate the timer 423.

Mode 3: When the spindle 3 reaches a predetermined position, the activator 21 is in a stall state. At this time, the current of the actuator 21 is larger than that in its steady state, and the current waveform is shown in FIGS. 8a and 8b. With this waveform, the micro-controller 42 is instructed to stop counting the number of pulses and the operation of the timer 423.

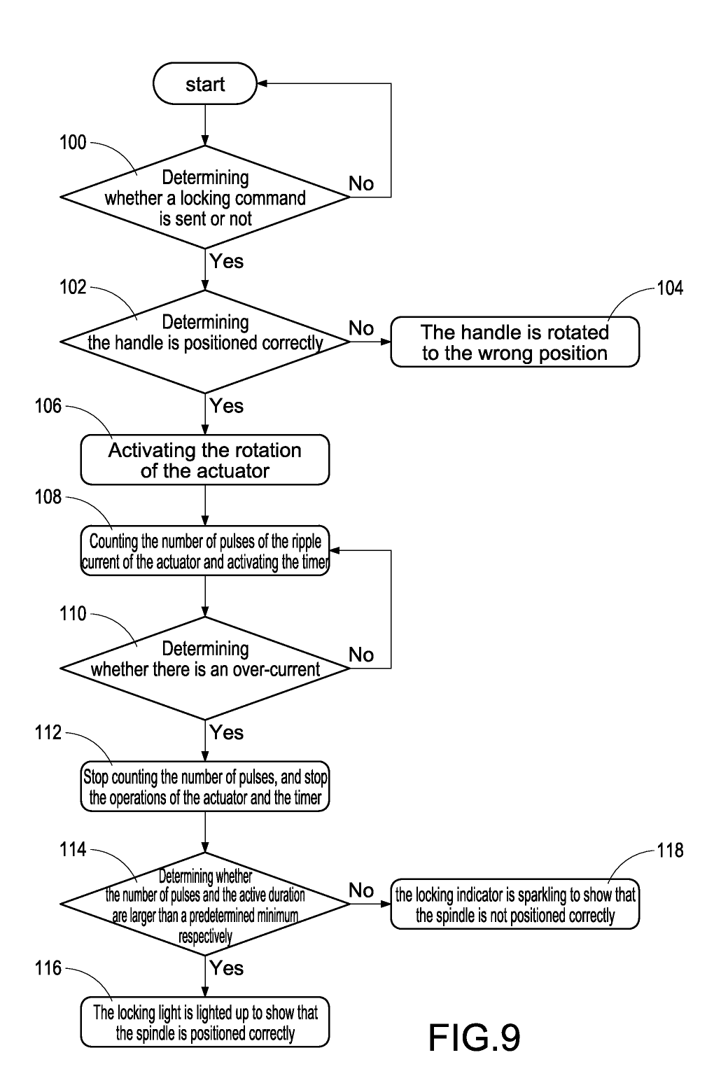

Please refer to FIG. 9, which is a flow chart showing the steps of locking the steering lock of the present invention. As shown in this figure, the electric steering lock for a motorcycle according to the present invention is cooperated with a PKE system for a motorcycle. The engine control unit (ECU) authenticates the signal sent by the Key Fob, thereby controlling the steering lock.

First, after the user rotates the handle of the motorcycle to the left, in the step 100, the circuit board determines whether a locking command is sent or not. If positive, the process advances to the step 102.

In the step 102, the circuit board determines whether the handle is rotated to a correct position. If negative, the process advances to the step 104, which means the handle is rotated to the wrong position. If positive, the process advances to the step 106, in which the actuator is activated.

After the actuator is activated, the process advances to the step 108, in which the number of pulses of the ripple current of the actuator is counted, and the timer is activated.

In the step 110, the circuit board determines whether there is an over-current. If negative, the process returns to the step 108. If positive, the process advances to the step 112, in which the counting of pulses is ceased, and the actuator and the timer stop working

Then, the process advances to the step 114, in which the circuit board determines whether the number of pulses and the active duration of the actuator are larger than a predetermined minimum respectively. If positive, the process advances to the step 116, in which a locking indicator is lighted up to show that the spindle is positioned correctly. If negative, the process advances to the step 118, in which the locking indicator is sparkling to show that the spindle is not positioned correctly.

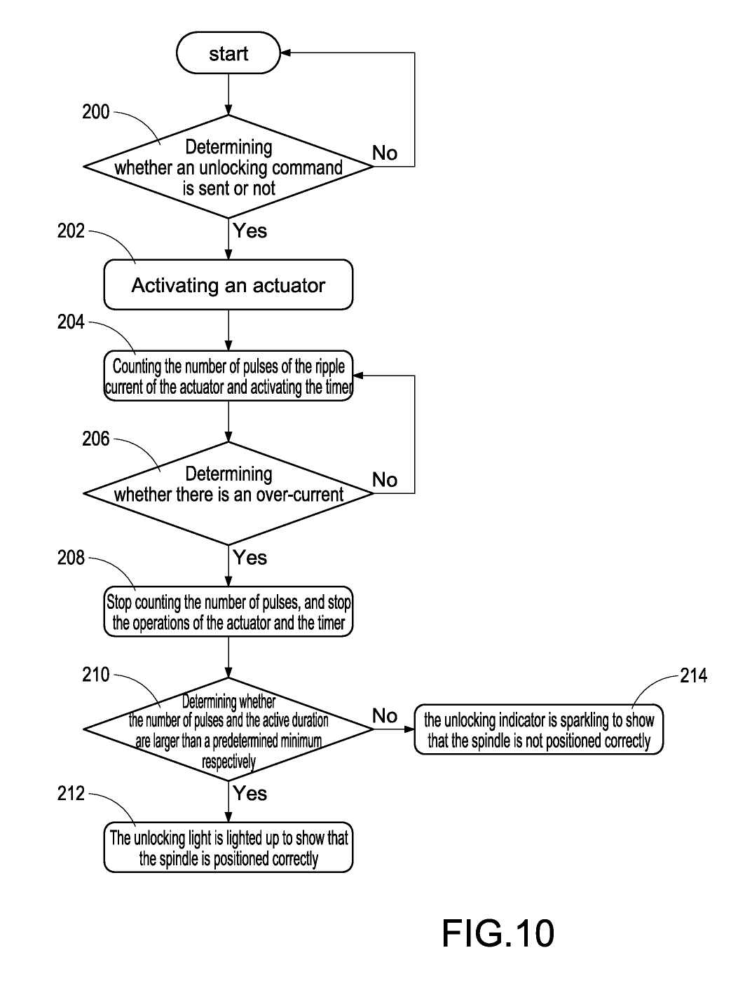

Please refer to FIG. 10, which is a flow chart showing the steps of unlocking the steering lock of the present invention. As shown in this figure, first, in the step 200, the circuit board determines whether an unlocking command is sent or not. If positive, the process advances to the step 202 to activate the actuator. Then, the process advances to the step 204.

After the actuator is activated, the process advances to the step 204, in which the number of pulses of the ripple current of the actuator is counted, and the timer is activated.

Then, the process advances to the step 206, in which the circuit board determines whether there is an over-current. If negative, the process returns to the step 204. If positive, the process advances to the step 208, in which the counting of pulses of the actuator is ceased, and the actuator and timer stop working

Then, the process advances to the step 210, in which the circuit board determines whether the number of pulses and the active duration of the actuator are larger than a predetermined minimum respectively. If positive, the process advances to the step 212, in which an unlocking indicator is lighted up to show that the spindle is positioned correctly. If negative, the process advances to the step 214, in which the unlocking indicator is sparkling to show that the spindle is not positioned correctly.

In addition, the shaft 211 of the actuator (motor) 21 of the present invention has a worm screw 212. The worm screw 212 can be self-locked, so that the spindle 3 can be prevented from being pushed back by an external force. Thus, the spindle can be also self-locked.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An electric steering lock for a motorcycle, arranged on one side of a steering stem, a positioning switch being pressed after a handle is rotated to one side, a button on the steering stem being pressed to automatically lock or unlock the steering lock under the control of a primary control chip, the electric steering lock including:
a housing having a first space and a second space, a front end of the second space having a through-hole;
a transmission assembly comprising an actuator, a first gear, a second gear and a sliding block each arranged within the first and second spaces in transmissive engagement with each other;
a spindle assembled with the sliding block and penetrating the through-hole to act in the second space; and
a circuit board arranged in a bottom of the housing and electrically connected with the actuator and the primary control chip;
wherein the primary control chip controls the circuit board to make the transmission assembly to drive the spindle to move accordingly, the sliding block touches an inner wall of the casing to make it unable to move forwards or backwards any more, a current of the actuator at this time is larger than that in its normal operation, the rotation of the actuator is ceased by the circuit board when a variation in current of the actuator is detected by the circuit board.

2. The electric steering lock for a motorcycle according to claim 1, wherein the housing has a casing, a front cover, an upper cover and a bottom cover, the interior of the casing has a partition for separating the interior of the casing into a first space and a second space, upper edges of the partition and an inner wall of the first space have a first group of recesses and a second group of recesses respectively; a front end of the first space has two blocks, each of the two blocks has an insertion slot; the front cover is assembled at the front end of the casing, one side of the front cover has an insertion strip, and the other side thereof has a protrusion, one side of the protrusion has an insertion strip, the insertion strip is inserted into the insertion slot, the protrusion has a through-hole corresponding to the through-hole of the second space; the upper cover is assembled above the casing; the bottom cover is locked to the bottom of the casing, the interior of the bottom cover has an accommodating space, a surrounding wall of the bottom cover has a notch.

3. The electric steering lock for a motorcycle according to claim 2, wherein the actuator is a motor arranged in the first space, the actuator has a shaft, and the shaft extends to form a worm screw.

4. The electric steering lock for a motorcycle according to claim 3, wherein both side surfaces of the first gear have a concentric shaft respectively, the shaft spans the second group of recesses on the upper edges of the partition and the inner wall, the first gear is located in the first space to be engaged with the worm screw, one of the shafts has a pinion at its end, the pinion is located in the second space.

5. The electric steering lock for a motorcycle according to claim 4, wherein one side of the second gear has a long shaft, the long shaft spans the first group of recesses on the upper edges of the partition and the inner wall, the second gear is located in the second space to be engaged with the pinion, the other side surface of the second gear has an eccentric shaft.

6. The electric steering lock for a motorcycle according to claim 5, wherein the sliding block has an opening, the eccentric shaft penetrates the opening and moves therein to drive the sliding block to move accordingly, a front end of the sliding block has a T-shape slot.

7. The electric steering lock for a motorcycle according to claim 6, wherein the spindle has a pillar, one end of the pillar has a T-shape portion connected in the T-shape slot.

8. The electric steering lock for a motorcycle according to claim 1, wherein the circuit board further including a connector electrically connected to the primary control chip.

9. The electric steering lock for a motorcycle according to claim 8, wherein the circuit board further comprises:
a micro-controller for receiving a forward rotation signal and a reverse rotation signal inputted by an external device;
a driving unit electrically connected to the micro-controller and the actuator, the micro-controller receiving the forward rotation signal and the reverse rotation signal inputted by the external device to activate the driving unit;
a current sensing unit electrically connected between the driving unit and the actuator for sensing a variation in current there between;
an amplifier electrically connected to the current sensing unit for amplifying a current sensed by the current sensing unit;
a first comparer electrically connected to the amplifier and the micro-controller for processing a current waveform outputted by the amplifier into a ripple signal, and sending the ripple signal to the micro-controller;
a second comparer electrically connected to the amplifier and the micro-controller for processing a current waveform outputted by the amplifier into an over-current signal, and sending the over-current signal to the micro-controller; and
a power supply electrically connected to the micro-controller and the driving unit for supplying necessary power to the circuit board and the actuator.

10. The electric steering lock for a motorcycle according to claim 9, wherein the micro-controller has a timer.
